(19) United States
(12) Patent Application Publication
(10) Pub. No.: US 2007/0067792 A1
(43) Pub. Date: Mar. 22, 2007

(54) Recording apparatus and photosensitive recording medium cartridge for use in the same

(75) Inventors: Kiichiro Kitagawa, Kanagawa (JP); Kiyoo Morita, Kanagawa (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/522,387

(22) Filed: Sep. 18, 2006

(30) Foreign Application Priority Data
Sep. 16, 2005 (JP) P2005-269791

(51) Int. Cl. G11B 23/03

(52) U.S. Cl. 720/744; 720/743

(57) ABSTRACT

A recording apparatus including: a shutter open/close mechanism 80 for sliding a shutter of a cartridge mounted in the recording apparatus through a mounting port having an openable cover; a recorder/reproducer portion 95 for performing reading/writing on a recording disc in the cartridge in the condition that the shutter has been slid so that an opening in a body of the cartridge is opened; a control portion 91 for controlling drive of the shutter open/close mechanism 80 and the recorder/reproducer portion 95; and a detection sensor 88 for detecting fitting of a shield plate portion formed in the circumference of the openable cover into the groove portion formed in the circumference of the mounting port when the mounting port is closed with the openable cover. When the mounting port is closed with the openable cover, the control portion 91 drives the shutter open/close mechanism 80, in response to a detection signal transmitted from the detection sensor 88, so as to start a shutter open operation for opening the shutter of the cartridge before the openable cover is closed.

### FIELD OF THE INVENTION

The present invention relates to a recording apparatus for performing reading/writing on a photosensitive recording medium such as a holographic recording medium stored in a cartridge, and improvement in a photosensitive recording medium cartridge for use in the recording apparatus.

### BACKGROUND OF THE INVENTION

A holographic recording medium on which data are recorded holographically has been invented (e.g. see JP-A-2004-029476). The holographic recording medium is a photosensitive recording medium in which holographic recording layers each made of a photosensitive material are provided on a disc-shaped support. Data are multiplexedly recorded on the holographic recording medium as interference fringes of laser light, so that the holographic recording medium can obtain a larger data recording capacity than that of a DVD which is a recording medium heretofore widespread. Exposure of the holographic recording layers to light or deposition of dust on the holographic recording layers exerts a bad influence on the performance of the holographic recording medium. For this reason, the holographic recording medium is dealt with in the condition that the holographic recording medium is stored in a cartridge having a light-shielding function and a dustproof function (e.g. see JP-A-2003-317422 (corresponding to US 2003/0198177 A1)).

After the cartridge is mounted in a recording apparatus, a shutter is opened so as to expose the recording medium partially so that writing/reading can be performed on the recording medium by an optical pickup. On this occasion, however, there is a possibility that light or dust enters through a cartridge mounting port formed in the recording apparatus to thereby exert a bad influence on the recording medium.

For this reason, there has been known a recording apparatus to which a cover for closing a mounting port is attached so that the mounting port can be closed with the cover after a cartridge is mounted in the recording apparatus (e.g. see JP-A-8-339658).

### SUMMARY OF THE INVENTION

In the recording apparatus, if the cover is not closed completely, entrance of light or dust through the mounting port cannot be prevented.

That is, unless the cover is closed completely, the shutter of the cartridge mounted in the recording apparatus is not allowed to be opened for performing writing/reading on the recording medium by an optical pickup, so that it is difficult for the recording apparatus to start a rapid operation.

The invention is accomplished under such circumstances. An object of the invention is to provide a recording apparatus capable of rapidly starting reading/writing on a photosensitive recording medium after a cartridge is mounted in the recording apparatus, and a photosensitive recording medium cartridge for use in the recording apparatus.

In order to achieve the object, the recording apparatus according to the invention is a recording apparatus including: a shutter open/close mechanism for sliding a shutter of a cartridge mounted into the recording apparatus through a mounting port having an openable cover; a recorder/reproducer portion for performing reading/writing on a disc-shaped photosensitive recording medium stored in the cartridge in the condition that the shutter has been slid so that an opening formed in a body of the cartridge is opened; and a control portion for controlling drive of the shutter open/close mechanism and the recorder/reproducer portion, wherein: the openable cover has a front plate portion for covering the mounting port, and a shield plate portion formed integrally with the circumference of the front plate portion so that the shield plate portion can be fitted into a groove portion formed in the circumference of the mounting port; the recording apparatus further includes a detection sensor for detecting the fitting of the shield plate portion of the openable cover into the groove portion in the middle of closing the mounting port with the openable cover; and when the mounting port is closed with the openable cover after the cartridge is mounted through the mounting port, the control portion drives the shutter open/close mechanism, in response to a detection signal transmitted from the detection sensor, to start a shutter open operation of the cartridge before the openable cover is closed.

In the recording apparatus according to the invention, the shield plate portion of the openable cover is fitted into the groove portion of the recording apparatus body so as to achieve a labyrinth-shaped light-shielding state. At the point of time when light or dust has been prevented from entering through the mounting port, the shutter of the cartridge is opened so as to start writing/reading on the photosensitive recording medium. Thus, a writing/reading operation can be performed rapidly while light or dust is prevented from entering the cartridge.

The photosensitive recording medium cartridge according to the invention is a cartridge used in the recording apparatus, and including a light-shield plate attached to the outside of the cartridge body and having an opening hole which faces the opening formed in the cartridge body and which exposes a center and a recording surface of the photosensitive recording medium to the outside.

In the photosensitive recording medium cartridge according to the invention, the cartridge body can be shielded from light by the light-shield plate more surely. Dust can be prevented from entering the cartridge body more surely.

In the photosensitive recording medium cartridge, preferably, the photosensitive recording medium is a holographic recording medium. That is, the cartridge is excellent in light-shielding characteristic so that the cartridge is suitable for storing a recording medium made of a holographic recording medium.

In the photosensitive recording medium cartridge, preferably, the cartridge body is formed so that an inner surface of the cartridge body to the photosensitive recording medium and an outer surface of the cartridge body to the shutter are matted or embossed with a surface roughness Ra of 5 to 20 μm. In this manner, even when light enters the cartridge or between the cartridge body and the shutter, the light can be diffused or attenuated by the rough surface so that influence of the light on the photosensitive recording medium can be reduced.

In the photosensitive recording medium cartridge, preferably, the cartridge body includes a first shell substantially shaped like a plate, and a second shell lap-welded with the first shell, the first and second shells being made of one and the same thermoplastic or similar thermoplastics, the other components inclusive of the shutter being made of materials different from the materials of the first and second shells. Thus, when the first and second shells are welded to each other, the first and second shells can be prevented from being welded to the other components.

In the photosensitive recording medium cartridge, preferably, 0.01% by weight to 5.00% by weight of a light-shield substance are added to a plastic used for molding each of the first and second shells and the shutter. Thus, light transmittance of the cartridge body and the shutter can be reduced so that light-shielding performance of the cartridge can be improved.

In the photosensitive recording medium cartridge, preferably, 0.01% by weight to 2.00% by weight of carbon black are added to a plastic used for molding each of the first and second shells and the shutter. Thus, light transmittance of the cartridge body and the shutter can be reduced so that light-shielding performance of the cartridge can be improved.

In the photosensitive recording medium cartridge, preferably, 0.1% by weight to 5.0% by weight of a silicon-based lubricant are added to a plastic used for molding each of the first and second shells and the shutter. Thus, movement of the shutter becomes smooth so that chips etc. can be prevented from being generated due to friction between the shutter and the cartridge body.

According to the invention, the shield plate portion of the openable cover is fitted into the groove portion of the recording apparatus body so as to achieve a labyrinth-shaped light-shielding state. At the point of time when light or dust has been prevented from entering through the mounting port, the shutter of the cartridge is opened so as to start writing/reading on the photosensitive recording medium. Thus, a writing/reading operation can be performed rapidly while light or dust is prevented from entering the cartridge.

### BRIEF DESCRIPTION OF THE DRAWINGS

FIG. 1 is a perspective view showing the shape of external appearance of a cartridge according to an embodiment of the invention.

FIG. 2 is an external appearance perspective view showing an opposite surface of the cartridge.

FIG. 3 is an external appearance perspective view showing a state in which a shutter of the cartridge is opened.

FIG. 4 is an exploded perspective view showing the configuration of the cartridge.

FIGS. 5A to 5C are sectional views of the cartridge in a mounting direction in which FIG. 5A is an overall view, FIG. 5B is an important part enlarged view, and FIG. 5C is another important part enlarged view.

FIG. 6 is an exploded perspective view showing the configuration of a lock mechanism.

FIGS. 7A to 7C are views for explaining operation of the lock mechanism shown in FIG. 6.

FIG. 8 is an explanatory view showing one example of various mechanisms for opening the shutter.

FIG. 9 is a schematically sectional view for explaining the structure of a recording apparatus according to the embodiment.

FIG. 10 is a perspective view in a mounting port portion of the recording apparatus.

FIG. 11 is a front view of the recording apparatus.

FIG. 12 is a block diagram for explaining a function of the recording apparatus.

FIGS. 13A to 13E are schematically sectional views for explaining an operation of the recording apparatus.

FIGS. 14A to 14D are schematically sectional views for explaining the operation of the recording apparatus.

FIG. 15 is a flow chart for explaining control of the recording apparatus.

FIG. 16 is a perspective view showing external appearance of a cartridge having another structure.

FIG. 17 is a perspective view showing the shape of external appearance of a rear surface side of the cartridge.

FIG. 18 is an external appearance perspective view showing the state where a shutter of the cartridge is opened.

FIGS. 19A and 19B are sectional views of the cartridge in a direction perpendicular to a mounting direction.

FIG. 20 is an exploded perspective view showing the configuration of the shutter.

### DETAILED DESCRIPTION OF THE INVENTION

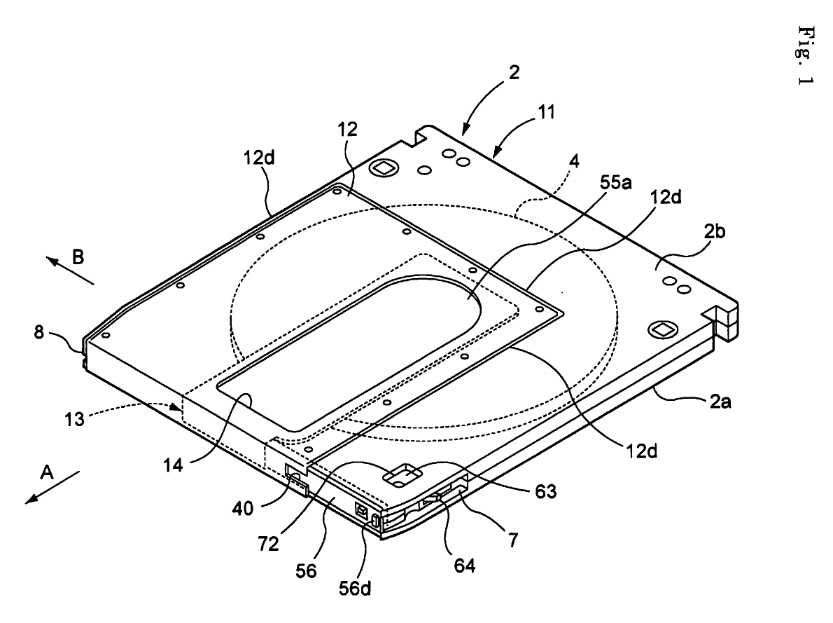

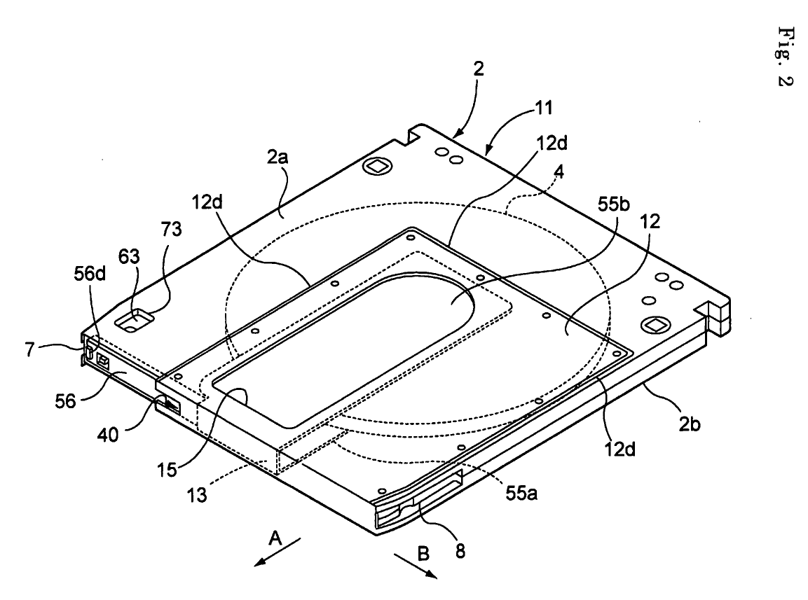

An embodiment of the invention will be described below in detail with reference to the drawings. FIGS. 1 to 3 are perspective views each showing the shape of external appearance of a holographic recording medium cartridge (hereinafter referred to as “cartridge” simply) according to the embodiment of the invention. FIG. 1 is a perspective view showing a state in which a surface of the cartridge faces up. FIG. 2 is a perspective view showing a state in which an opposite surface of the cartridge faces up. FIG. 3 is a perspective view showing a state in which a shutter is in an open position and a disc-shaped holographic recording medium (hereinafter referred to as “recording disc”) is received rotatably in a disc storage portion.

As shown in FIG. 1, the cartridge 2 is mounted, in a direction of an arrow A, into a holographic recording apparatus etc. for handling the cartridge. Positioning grooves 7 and 8 are provided in opposite side surfaces of a front end of the cartridge 2 in the mounting direction. When the cartridge 2 is mounted in any one of various apparatuses such as a holographic recording apparatus etc., positioning members provided in the apparatus are inserted into the positioning grooves 7 and 8.

A recording disc 4 is a holographic recording disc having a hole formed in its central portion. Holographic recording layers are provided in opposite surfaces of the recording disc 4. For example, on each of the holographic recording layers, data are multiplexedly recorded as interference fringes of laser light by the laser light in a range of from a green wavelength of 532 nm to a blue wavelength of 405 nm. Incidentally, a reinforcement material may be added to the hole portion of the recording disc 4. In order to record data on each of the opposite recording surfaces of the recording disc 4, the cartridge 2 is set in the holographic recording apparatus while an A surface 2a or a B surface 2b of the cartridge 2 is made to face up as shown in FIG. 2.

The cartridge 2 includes a cartridge body 11, a light-shield plate 12, and a shutter 13. A disc storage portion 3 is provided in the cartridge body 11. The light-shield plate 12 is attached to the outside of the cartridge body 11 so as to sandwich the cartridge body 11. The shutter 13 is put between the cartridge body 11 and the light-shield plate 12. Outer holes 14 and 15 each substantially shaped like a rectangle as a second opening (open hole) are formed in upper and lower surfaces of the light-shield plate 12, respectively. These outer holes 14 and 15 are closed with a first shutter plate 55a and a second shutter plate 55b when the shutter 13 is in a close position.

When the shutter 13 is moved toward an open position in a direction of an arrow B as shown in FIG. 3, inner holes 18 and 19 are opened together with the outer holes 14 and 15. The inner holes 18 and 19 have the same shapes as those of the outer holes 14 and 15 and are provided in the cartridge body 11 so as to face the outer holes 14 and 15 respectively. Thus, a central portion 4a and recording surfaces 4b of the recording disc 4 which is received in the disc storage portion 3 are exposed to the outside.

The shutter 13 is urged to the close position by a built-in shutter spring and locked in the close position by a lock mechanism. The lock based on the lock mechanism is released in such a manner that while a second lock member 64 protruding in the positioning groove 7 is forced into the inside of the cartridge 2, a first lock member 63 exposed from either of openings 73 and 72 in the A surface 2a and the B surface 2b of the cartridge 2 is slid toward a rear end side of the cartridge in the mounting direction. In this manner, the shutter 13 is locked in the close position by the lock mechanism in the condition that the shutter 13 cannot be unlocked without the two-stage operation. Accordingly, the shutter 13 is prevented from being opened unintentionally.

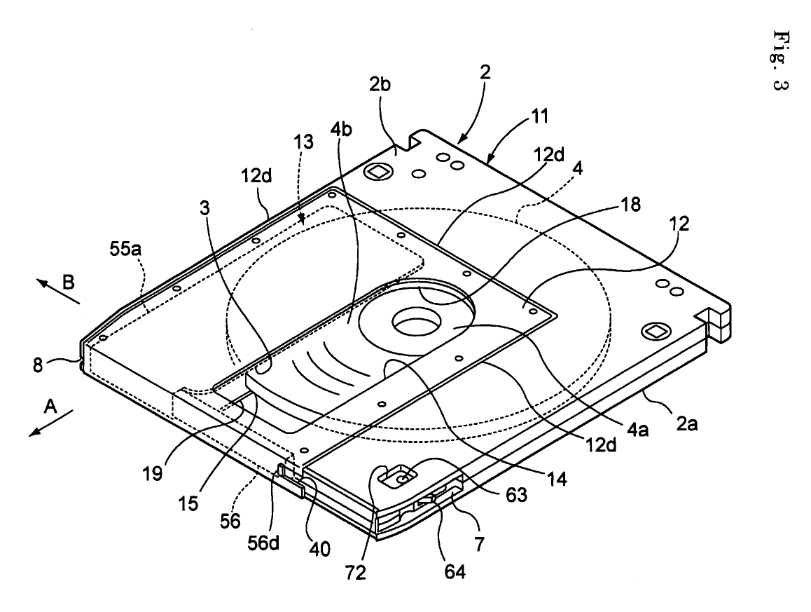

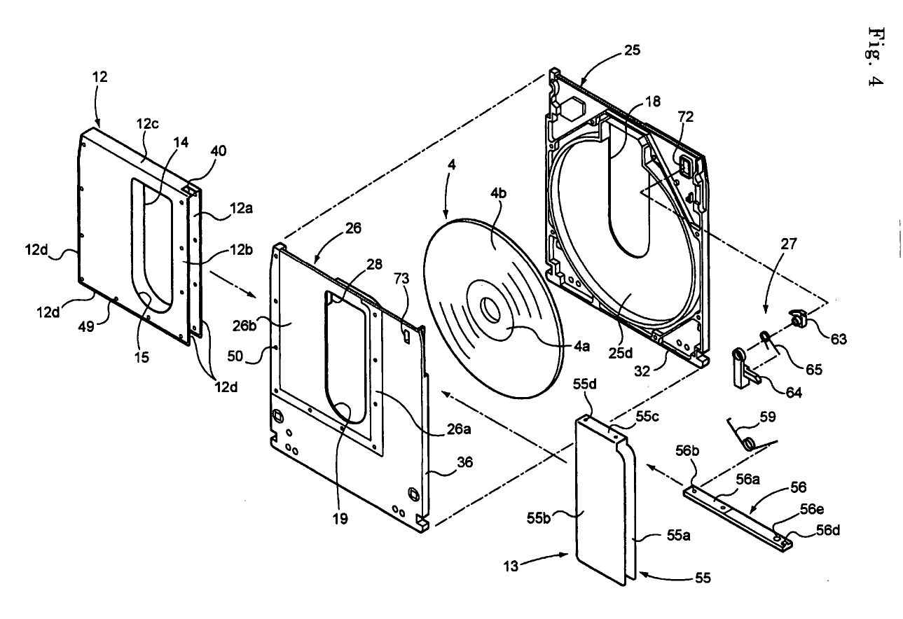

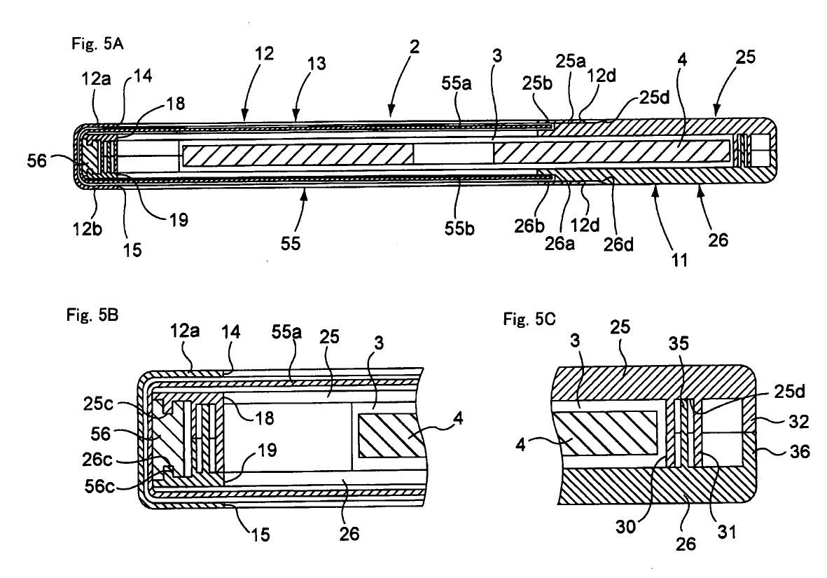

FIG. 4 is an exploded perspective view showing the configuration of the cartridge 2. FIG. 5A is a sectional view of the cartridge in the mounting direction. FIG. 5B is an enlarged view of a portion in FIG. 5A. FIG. 5C is an enlarged view of another portion in FIG. 5A.

As shown in FIG. 4, the cartridge body 11 includes a first shell 25 substantially shaped like a plate, a second shell 26 connected to the first shell 25, and a lock mechanism 27 put between the first shell 25 and the second shell 26 for locking the shutter 13.

For example, the first shell 25 and the second shell 26 are formed by injection molding of one and the same thermoplastic or similar thermoplastics in each of which a light-shield substance and a lubricant are added. As shown in FIG. 5C which is an enlarged sectional view of an end edge portion of the cartridge 2, a first light-shield wall 30, a second light-shield wall 31 and a protrusive line 32 are provided in the inner surface of the first shell 25. The first light-shield wall 30 is a protrusive line formed into a size with a diameter larger than the outer diameter of the recording disc 4. The second light-shield wall 31 is provided in the outside of the first light-shield wall 30. The protrusive line 32 is provided in the whole circumference of the end edge. The inner hole 18 exposing the central portion 4a and the recording surface 4b of the recording disc 4 to the outside is provided in the inside of the first light-shield wall 30.

A third light-shield wall 35 and a protrusive line 36 are provided in the inner surface of the second shell 26. The third light-shield wall 35 is a protrusive line formed into a size with a diameter larger than the outer diameter of the recording disc 4. The third light-shield wall 35 is inserted between the first light-shield wall 30 and the second light-shield wall 31 of the first shell 25. The protrusive line 36 is provided in the whole circumference of the end edge. The inner hole 19 exposing the central portion 4a and the recording surface 4b of the recording disc 4 to the outside is provided in the inside of the third light-shield wall 35.

When the first shell 25 is piled on the upper surface of the second shell 26 while the recording disc 4 is placed in the inside of the third light-shield wall 35 of the second shell 26, the third light-shield wall 35 is inserted between the first light-shield wall 30 and the second light-shield wall 31 so that the front end of the third light-shield wall 35 abuts on an inner surface 25d of the first shell 25. The disc storage portion 3 is formed from these light-shield walls 30, 31 and 35 and the inner surfaces of the first and second shells 25 and 26. The side wall of the disc storage portion 3 is formed in a labyrinth-shaped light-shielding structure complicatedly made of the three light-shield walls 30, 31 and 35. With this structure, even when light or dust enters through a mating portion between the first and second shells 25 and 26, the light or dust never goes into the disc storage portion 3.

The front end of the third light-shield wall 35 of the second shell 26 is fixed to the inner surface 25d of the first shell 25 by ultrasonic welding. Accordingly, the first shell 25 and the second shell 26 are connected firmly to each other, so that no gap is formed in the mating portion between the first shell 25 and the second shell 26.

Also as shown in FIG. 5A, light-shield plate attachment surfaces 25a and 26a each offset inward so as to be formed into a size slightly larger than the shape of the light-shield plate 12 are formed in the outer surfaces of the first shell 25 and the second shell 26.

A material, such as an aluminum alloy, which can obtain light-shielding characteristic, corrosion resistance, decoration effect and processablity and which is light in weight and strong is used as the material of the light-shield plate 12. Alternatively, the light-shield plate 12 may be formed of a plastic. In this case, a plastic in which a light-shield substance and a lubricant are added is preferably used in order to secure light-shielding characteristic and slidability of the shutter 13. As shown in FIG. 4, the light-shield plate 12 is formed by making outer holes 14 and 15 and a notch 40 in a thin aluminum alloy plate and bending the thin aluminum alloy plate substantially into a U shape in section. The notch 40 is provided for gaining a movement range of the shutter 13. In this manner, the light-shield plate 12 is provided with a first plate portion 12a having the outer hole 14, a second plate portion 12b having the outer hole 15, and a third plate portion 12c including the notch 40 and connected to the first and second plate portions 12a and 12b.

The light-shield plate 12 is attached to the light-shield plate attachment surfaces 25a and 26a of the cartridge body 11 in such a manner that the B surface 2b and the A surface 2a of the cartridge body 11 are held by the first and second plate portions 12a and 12b and the front end of the cartridge body 11 in the mounting direction A is covered with the third plate portion 12c. The light-shield plate attachment surfaces 25a and 26a are offset inward to have a depth not smaller than the thickness of the light-shield plate 12 so that the outer surface of the light-shield plate 12 attached to the cartridge body 11 does not protrude from the surface of the cartridge 2.

As shown in FIG. 4, small holes 49 are formed at intervals of an approximately equal pitch in the outer circumferences of the first and second plate portions 12a and 12b of the light-shield plate 12. In addition, pins 50 each having a length slightly larger than the thickness of the light-shield plate 12 are formed integrally with the light-shield plate attachment surfaces 25a and 26a of the first and second shells 25 and 26 in positions corresponding to the holes 49 of the light-shield plate 12.

When the light-shield plate 12 is attached to the outside of the cartridge body 11 (the light-shield plate attachment surfaces 25a and 26a), the pins 50 of the first and second shells 25 and 26 are inserted into the holes 49 so as to protrude from the surface of the light-shield plate 12.

In addition to the aforementioned method, an adhesive agent, double-sided adhesive tape, screwing, etc. may be used as the method for fixing the light-shield plate 12 to the cartridge body 11. When the light-shield plate 12 is molded out of a plastic, various kinds of welding can be used.

As shown in FIG. 4, the shutter 13 includes a shutter member 55 and a slide member 56. The shutter member 55 is formed by bending a thin light-shield plate substantially into a U shape. The slide member 56 is shaped like a long and narrow plate and attached to the shutter member 55. For the same reason as the light-shield plate 12, for example, the shutter member 55 is formed of an aluminum alloy. Alternatively, the shutter member 55 may be formed of a plastic. In this case, a plastic in which a light-shield substance and a lubricant are added is preferably used in order to secure light-shielding characteristic and slidability. The slide member 56 is formed of a plastic in which a light-shield substance and a lubricant are added.

The shutter member 55 includes a first shutter plate 55a, a second shutter plate 55b and a joint 55c. The first shutter plate 55a is inserted between the outer surface of the first shell 25 and the first plate portion 12a of the light-shield plate 12. The second shutter plate 55b is inserted between the outer surface of the second shell 26 and the second plate portion 12b of the light-shield plate 12. The joint 55c is connected to the first and second shutter plates 55a and 56a while the slide member 56 is attached to the joint 55c.

Shutter slide surfaces 25b and 26b each offset inward to have a depth not smaller than the thickness of the shutter member 55 are formed in the inside of the light-shield plate attachment surfaces 25a and 26a in the outer surfaces of the first and second shells 25 and 26. In this manner, the shutter 13 can move between the cartridge body 11 and the light-shield plate 12 so smoothly that generation of chips etc. due to the movement of the shutter 13 can be suppressed. Incidentally, the shutter slide surfaces 25b and 26b may be roughened in order to diffuse incident light. Similarly, the inner surface of the light-shield plate 12 and the inner and outer surfaces of the shutter 13 may be roughened.

The slide member 56 is put slidably between the first shell 25 and the second shell 26 so that the upper surface of the slide member 56 is exposed from the front end surface of the cartridge body 11 in the mounting direction. An attachment surface 56a to be attached to the inner surface of the joint 55c of the shutter member 55 is provided in one end portion of the upper surface of the slide member 56. For example, two pins 56b are formed integrally with the attachment surface 56a. When the two pins 56b are inserted into two holes 55d provided in the joint 55c and front ends of the pins 56b are melted down by heat, the shutter member 55 and the slide member 56 are fixed to each other. Incidentally, an adhesive agent, double-sided adhesive tape, etc. may be used for the fixation. Various kinds of welding may be used when the shutter member 55 is formed of a plastic. In addition, screwing may be used.

As shown in FIG. 5B, grooves 56c are formed along a longitudinal direction in side surfaces of the slide member 56. Protrusive lines 25c and 26c provided in the inner surfaces of the first and second shells 25 and 26 and on the front end side in the mounting direction are inserted into the grooves 56c. By means of the grooves 56c and the protrusive lines 25c and 26c, the slide member 56 can be moved slidably without being displaced from the cartridge body 11.

A to-be-operated portion 56d to be operated for opening the shutter 13 is formed integrally with the other end portion of the upper surface of the slide member 56. When the to-be-operated portion 56d provided thus is operated to extend the slide member 56 with respect to the shutter member 55 in a direction to close the shutter, the slide member 56 is exposed to the outside without being hidden by the third plate portion 12c of the light-shield plate 12. The notch 40 in the third plate portion 12c of the light-shield plate 12 is provided for avoiding interference with the to-be-operated portion 56d when the shutter 13 is moved to the open position (see FIG. 3).

The shutter 13 is urged in the closing direction by a shutter spring 59. For example, the shutter spring 59 is made of a torsion coil spring. Opposite ends of the shutter spring 59 are stopped by the slide member 56 and the inner surface of the first shell 25.

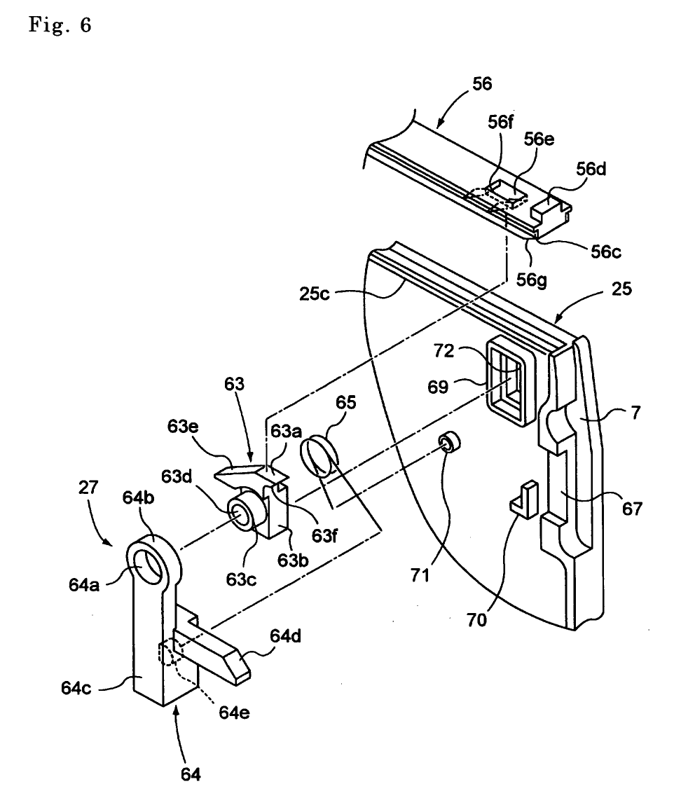

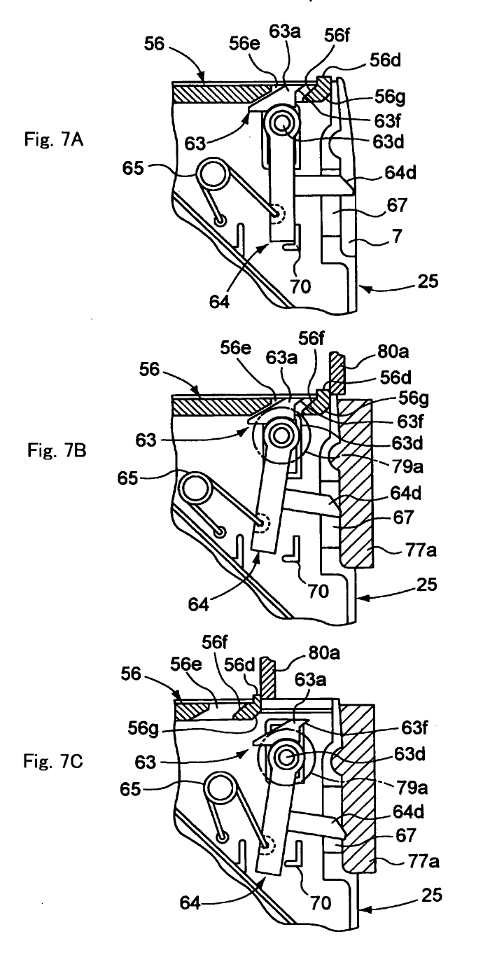

Next, the lock mechanism will be described with reference to FIG. 6, FIGS. 7A to 7C and FIG. 8. FIG. 6 is an exploded perspective view showing the configuration of the lock mechanism. FIGS. 7A to 7C are views for explaining operation of the lock mechanism shown in FIG. 6. FIG. 8 is an explanatory view showing one example of various mechanisms of a recording apparatus for opening the shutter.

As shown in FIG. 6, a lockable groove 56e shaped like a rectangular hole is formed in the slide member 56 adjacently to the to-be-operated portion 56d. As shown in FIG. 7A, an engagement inclined surface 56f inclined in the other end side (in the direction of the to-be-operated portion 56d) of the slide member 56 little by little toward the front of the cartridge 2 in the mounting direction A is formed in the outer side surface of the lockable groove 56e in the longitudinal direction of the slide member 56. A corner portion between a right end surface and a lower surface of the slide member 56 as shown in the drawings is chamfered so as to form a guide inclined surface 56g substantially in parallel to the engagement inclined surface 56f.

As shown in FIG. 6, a lock mechanism 27 includes a first lock member 63, a second lock member 64, and a lock spring 65. The first lock member 63 locks the shutter 13 in the close position. The second lock member 64 locks movement of the first lock member 63. The lock spring 65 urges the second lock member 64 in an illustrated counterclockwise direction and upward.

The first lock member 63 includes a lock pawl 63a, a rectangular slide portion 63b, a cylindrical boss 63c, and an operation hole 63d. The lock pawl 63a locks the shutter 13 in the close position when the lock pawl 63a engages with the lockable groove 56e formed in the slide member 56. The slide portion 63b is provided integrally with the lock pawl 63a. The boss 63c is formed in a surface of the slide portion 63b facing the second shell 26. The operation hole 63d is formed by perforating the boss 63c and the slide portion 63b.

A slope 63e provided for inducing engagement with the lockable groove 56e when the shutter 13 is moved from the open position to the close position is formed in the lock pawl 63a so as to be substantially parallel to the engagement inclined surface 56f of the slide member 56. A hook portion 63f which is an inclined surface substantially parallel to the engagement inclined surface 56f of the lockable groove 56e is formed in the illustrated right side of the lock pawl 63a. When the slide member 56 is moved in the direction of the arrow B to open the shutter 13, the hook portion 63f engages with the engagement inclined surface 56f so as to surely stop the movement of the slide member 56.

The second lock member 64 includes a link portion 64b, a rotation portion 64c, a pressure piece 64d, and a spring stoppage portion 64e. The link portion 64b is provided with a hole 64a inserted onto the outer circumference of the boss 63c of the first lock member 63 rotatably. The rotation portion 64c is provided integrally with the link portion 64b so as to rotate around the boss 63c. The pressure piece 64d is provided erectly and vertically to a side surface of the rotation portion 64c. The spring stoppage portion 64e stops one end of the lock spring 65.

The first lock member 63 is moved between a first lock position as shown in FIG. 7A and a first unlock position as shown in FIG. 7C. In the first lock position, the hook portion 63f of the lock pawl 63a engages with the engagement inclined surface 56f of the lockable groove 56e of the slide member 56. In the first unlock position, the hook portion 63f slides downward so as to release engagement with the lockable groove 56e.

In the first lock position shown in FIG. 7A, a right end portion of the hook portion 63f of the lock pawl 63a and a left end portion of the engagement inclined surface 56f of the lockable groove 56e are disposed on a vertical line or with a slight gap formed horizontally. In other words, in this state, the hook portion 63f does not engage with the engagement inclined surface 56f so that the first lock member 63 can move downward.

When the slide member 56 moves slightly in the center direction of the cartridge body 11, the engagement inclined surface 56f surely engages with the hook portion 63f so as to stop movement of the slide member 56. Incidentally, when the slide member 56 moves in the center direction of the cartridge body 11, the shutter 13 also moves toward the opening direction but the inner holes 18 and 19 are not opened because a movement distance for engagement of the engagement inclined surface 56f with the hook portion 63f is far smaller than an overlap quantity between the cartridge body 11 and the shutter 13 in the vicinities of the inner holes 18 and 19.

The second lock member 64 is moved between a second lock position as shown in FIG. 7A and a second unlock position as shown in FIG. 7B. In the second lock position, the second lock member 64 is urged by the lock spring 65 vertically so that the pressure piece 64d is protruded from a notch 67 in the positioning groove 7. In the second unlock position, the second lock member 64 is rotated clockwise.

A rectangular slide frame 69, a regulation piece 70 and a boss 71 are formed in the inner surface of the first shell 25. The slide portion 63b of the first lock member 63 is inserted into the slide frame 69 so as to be slidable in an up/down direction. The regulation piece 70 catches one side surface and the bottom of the rotation portion 64c of the second lock member 64 so as to prevent the rotation portion 64c from rotating in the illustrated counterclockwise direction and sliding downward. The other end of the lock spring 65 is stopped by the boss 71. An opening 72 is formed in the slide frame 69 so as to expose the operation hole 63d of the first lock member 63 to the outside from the outer surface of the first shell 25. Similarly, an opening 73 for exposing the operation hole 63d to the outside is formed in a position opposite to the opening 72 in the second shell 26.

FIG. 7A shows the state of the lock mechanism 27 of the cartridge 2 when the cartridge 2 is not in use. Since the second lock member 64 is urged upward by the lock spring 65, the lock pawl 63a of the first lock member 63 goes into the lockable groove 56e of the slide member 56. In this manner, when the shutter 13 is intended to slide from the close position to the open position, the engagement inclined surface 56f of the lockable groove 56e engages with the hook portion 63f of the lock pawl 63a so as to prevent the shutter 13 from sliding. The inclinations of the engagement inclined surface 56f and the hook portion 63f are shaped in such a manner that the engagement inclined surface 56f and the hook portion 63f are further interlocked with each other when the slide member 56 moves to open the shutter 13. Accordingly, movement of the slide member 56 is surely prevented.

Even if a rod or the like were inserted into the operation hole 63d of the first lock member 63 through either of the openings 72 and 73 provided in the first and second shells 25 and 26 in order to slide the first lock member 63, the lock cannot be released because the bottom of the second lock member 64 abuts on the regulation piece 70.

As shown in FIG. 8, for example, a pair of positioning members 77a and 77b, an unlock mechanism 78 and a shutter open/close mechanism 80 are incorporated in a holographic recording apparatus which is used after mounted with the cartridge 2. The unlock mechanism 78 operates the first lock member 63. The shutter open/close mechanism 80 slides the shutter 13 between the open position and the close position. The pair of positioning members 77a and 77b engage with the positioning grooves 7 and 8 in the opposite side surfaces of the mounted cartridge 2 so as to position the cartridge 2 in the insertion direction of the cartridge 2 and in a direction perpendicular to the insertion direction.

The unlock mechanism 78 has an engagement pin 79a and a slide mechanism. The engagement pin 79a is inserted into the operation hole 63d of the first lock member 63 through the opening 73 of the cartridge 2. The slide mechanism slides the engagement pin 79a in a direction to unlock the first lock member 63. Since data can be recorded on both surfaces of the recording disc 4, the cartridge 2 can be set in the apparatus while either of the A surface 2a and the B surface 2b of the cartridge 2 is made to face up. When the mounting surface is inverted, the lock mechanism 27 is located on a laterally reversed side. For this reason, the unlock mechanism 78 is provided with an engagement pin 79b to be used for inverse mounting so that the engagement pin 79b can engage with the operation hole 63d even when the cartridge 2 is mounted inversely. The engagement pins 79a and 79b are moved in a direction of an arrow simultaneously. Incidentally, when one of the engagement pins engages with the operation hole 63d, the other engagement pin will become an obstacle. For this reason, the engagement pins 79a and 79b may be designed to be retracted back when one of the engagement pins 79a and 79b abuts on the cartridge 2.

The shutter open/close mechanism 80 has an operating piece 80a and a slide mechanism. The operating piece 80a abuts on the outer side of the to-be-operated portion 56d of the slide member 56. The slide mechanism slides the operating piece 80a in a direction to slide the shutter 13. This shutter open/close mechanism 80 also has another operating piece 80b for handling inverse insertion of the cartridge 2. The operating pieces 80a and 80b are moved in directions of arrows simultaneously.

When the cartridge 2 is mounted in the holographic recording apparatus, the positioning member 77a is inserted into the positioning groove 7 as shown in FIG. 7B. The engagement pin 79a of the unlock mechanism 78 provided in this apparatus is inserted into the operation hole 63d of the first lock member 63. The operating piece 80a of the shutter open/close mechanism 80 is disposed on the outer side of the to-be-operated portion 56d of the slide member 56. The positioning member 77a presses the pressure piece 64d of the second lock member 64 against the urging force of the lock spring 65. The second lock member 64 rotates clockwise around the link portion 64b and the bottom of the rotation portion 64c leaves the regulation piece 70, so that the first lock member 63 can slide downward.

As shown in FIG. 7C, the unlock mechanism 78 slides the engagement pin 79a in an unlock direction so as to withdraw the lock claw 63a from the lockable groove 56e so that the engagement is released. When the shutter open/close mechanism 80 then slides the operating piece 80a toward the opening direction, i.e. leftward in the drawing, the shutter 13 is opened. In this manner, the lock based on the lock mechanism 27 is not released unless the second lock member 64 is rotated and the first lock member 63 is slid. Thus, it is possible to effectively prevent the shutter 13 from being opened unintentionally.

Various substances can be added as the light-shield substance added to the plastic used for molding the first shell 25 and the second shell 26. For example, it is preferable that 0.01% by weight to 5.00% by weight of a substance are added in accordance with the light-shield substance used. For example, carbon black can be used as the light-shield substance. Addition of carbon black can secure light-shielding characteristic and improve physical strength. The amount of carbon black to be added is preferably in a range of from 0.01% by weight to 2.00% by weight. Although an effect in improvement of light-shielding characteristic and physical strength is brought when the amount of carbon black to be added is larger than 0.01% by weight, physical strength is lowered if the amount of carbon black to be added is larger than 2.00% by weight.

For example, a silicone-based lubricant can be used as the lubricant. Because friction resistance is reduced by addition of the silicone-based lubricant, generation of chips due to movement of the shutter 13 can be suppressed. Moreover, generation of chips due to contact between the recording disc 4 and the inner wall of the cartridge body 11 on impact during the transit can be reduced. Moreover, handling property with respect to insertion into the apparatus is improved. In addition, because fluidity is improved, kneading characteristic at molding and processability at injection molding or the like are improved.

Incidentally, the amount of the silicone-based lubricant to be added is preferably in a range of from 0.1% by weight to 3.0% by weight. If the amount is not larger than 0.1% by weight, the effect is reduced. If the amount is not smaller than 3.0% by weight, fluidity is so excessive that a slip is generated between a screw and a resin at the time of kneading and molding. As a result, processability deteriorates, and the lubricant is bled out to a surface of a product and deposited on the recording disc 4, the user's hand or the like. This may cause disadvantages in handling property and external appearance. Incidentally, when copolymer silicone is used as the lubricant, the amount of the lubricant to be added can be increased to 5.0% by weight because such disadvantages hardly occur.

Next, a recording apparatus according to the embodiment will be described.

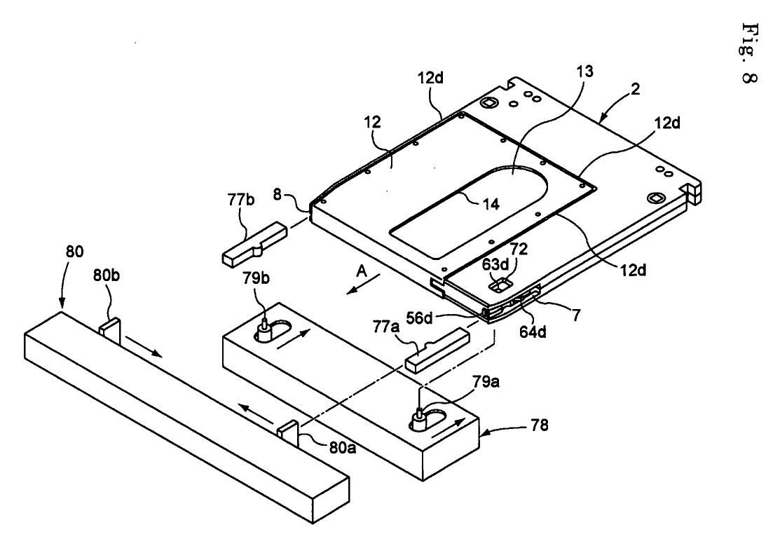

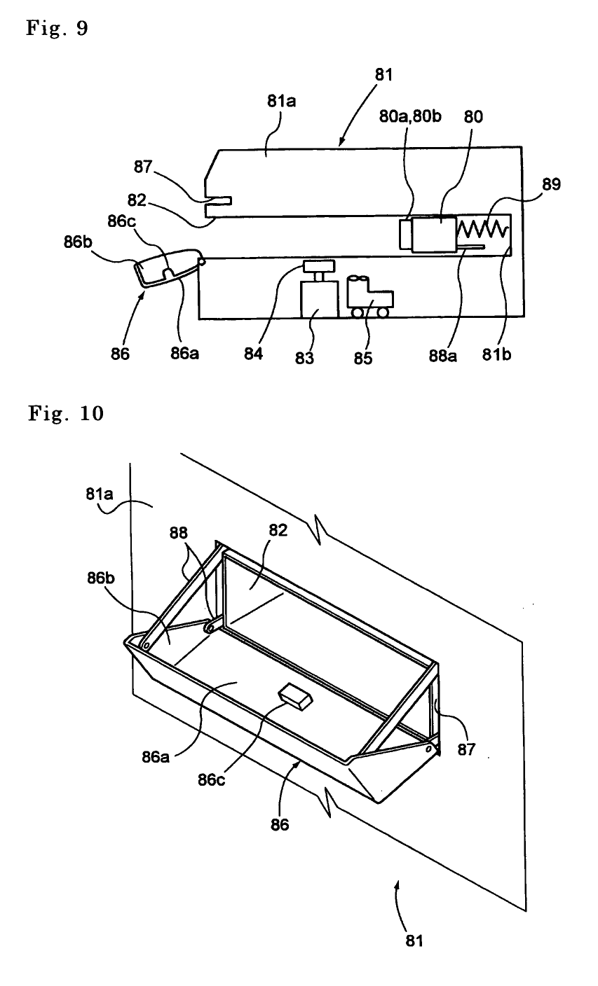

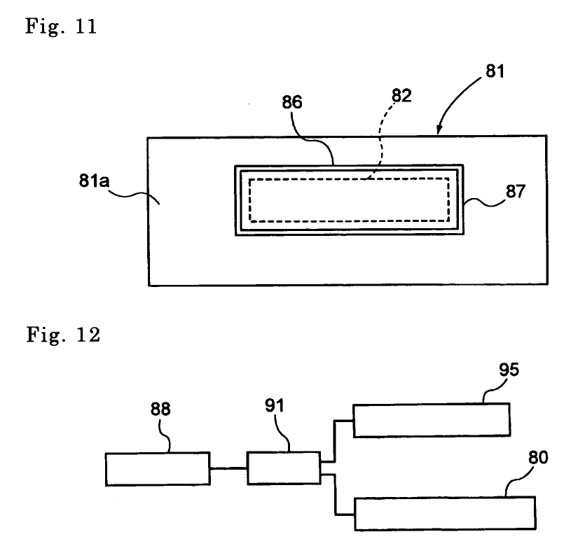

FIG. 9 is a schematically sectional view for explaining the structure of the recording apparatus according to the embodiment. FIG. 10 is a perspective view in a mounting port portion of the recording apparatus according to the embodiment. FIG. 11 is a front view of the recording apparatus according to the embodiment. FIG. 12 is a block diagram for explaining a function of the recording apparatus according to the embodiment.

As shown in FIG. 9, the structure of the recording apparatus 81 is formed in such a manner that a turntable 84 of a spindle motor 83 supports a center portion 4a of a recording disc 4 in a cartridge 2 which is mounted through a mounting port 82 so as to be positioned in the recording apparatus 81. This recording apparatus 81 drives the spindle motor 83 to rotate the recording disc 4 and drives a radially moving pickup 85 to write/read data into/from a recording surface 4b of the recording disc 4 in the lower surface side of the recording disc 4.

The shutter open/close mechanism 80 is disposed in a mounting-direction front side of the cartridge 2 mounted through the mounting port 82. The shutter open/close mechanism 80 is supported movably along the mounting direction of the cartridge 2 and urged rearward in the mounting direction of the cartridge 2 by a compression spring 89 provided between the shutter open/close mechanism 80 and a back plate 81b of a recording apparatus body 81a.

Moreover, the shutter open/close mechanism 80 is provided with a detection sensor 88 which will be described later. A detection pin 88a of the detection sensor 88 is protruded toward the back plate 81b of the recording apparatus body 81a.

When the cartridge 2 mounted through the mounting port 82 is pushed inward, the shutter open/close mechanism 80 is slid toward the mounting-direction front side against the urging force of the compression spring 89 by the cartridge 2 and the detection pin 88a of the detection sensor 88 abuts on the back plate 81b of the recording apparatus body 81a so as to be pushed back. Thus, a detection signal is outputted from the detection sensor 88.

An openable cover 86 is attached to the mounting port 82 of the cartridge 2 in the recording apparatus 81. As shown in FIG. 10, the openable cover 86 has a front plate portion 86a, and a shield plate 86b formed integrally with the circumference of the front plate portion 86a. A block-shaped pressure protrusion 86c is formed integrally on the inner surface side of the front plate portion 86a.

In the recording apparatus 81, a groove portion 87 is formed around the mounting port 82 in the recording apparatus body 81a. A pair of arms 88 are supported retractably from the groove portion 87 in opposite side portions of the mounting port 82 in the recording apparatus 81. These arms 88 are pivotally connected to the shield plate portion 86b in opposite side portions of the openable cover 86.

When this openable cover 86 in an open state is pushed toward the recording apparatus body 81a while rotated by a user, the mounting port 82 is closed with the openable cover 86. On this occasion, the shield plate portion 86b of the openable cover 86 is fitted into the groove portion 87 of the recording apparatus body 81a.

As shown in FIG. 11, the area of the front plate portion 86a in the openable cover 86 is larger than the area of the mounting port 82. Thus, the mounting port 82 is wholly covered with the front plate portion 86a when the mounting port 82 is closed with the openable cover 86.

Next, the function of the recording apparatus 81 will be described.

As shown in FIG. 12, the recording apparatus 81 is provided with a control portion 91. The detection sensor 88, a recorder/reproducer portion 95 and the shutter open/close mechanism 80 are connected to this control portion 91.

In this manner, a detection signal from the detection sensor 88 is transmitted to the control portion 91 and the control portion 91 transmits a drive control signal to the recorder/reproducer portion 95 and the shutter open/close mechanism 80.

That is, the control portion 91 drives the recorder/reproducer portion 95 and the shutter open/close mechanism 80 based on the detection signal from the detection sensor 88.

The recorder/reproducer portion 95 is constituted by the spindle motor 83 and the optical pickup 85. The recorder/reproducer portion 95 rotates a recording disc 4 by the spindle motor 83 so as to write/read data to/from a recording surface 4b of the recording disc 4 by the optical pickup 85.

Next, control of the recording apparatus 81 using the control portion 91 will be described.

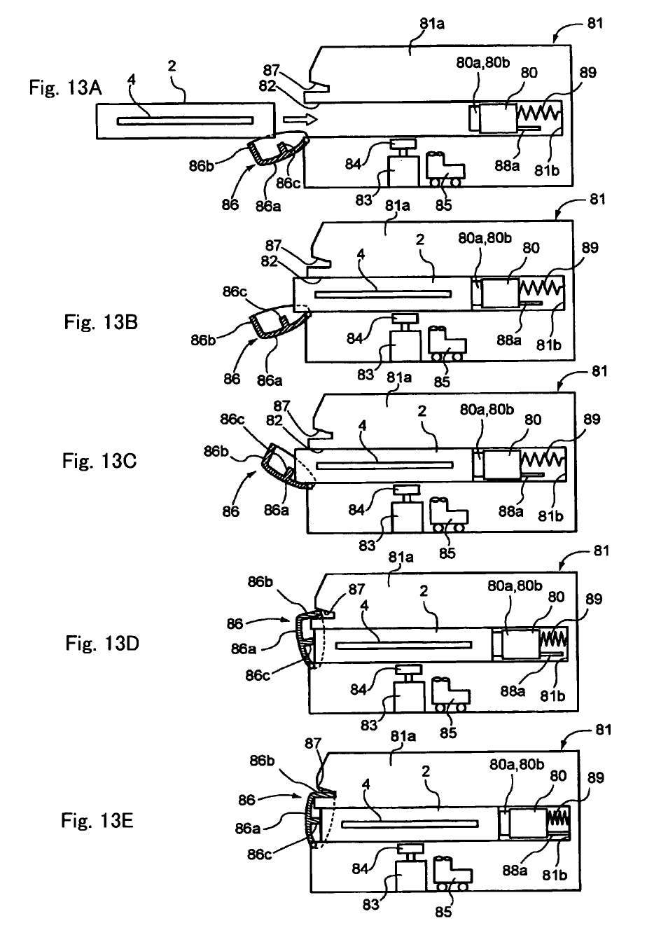

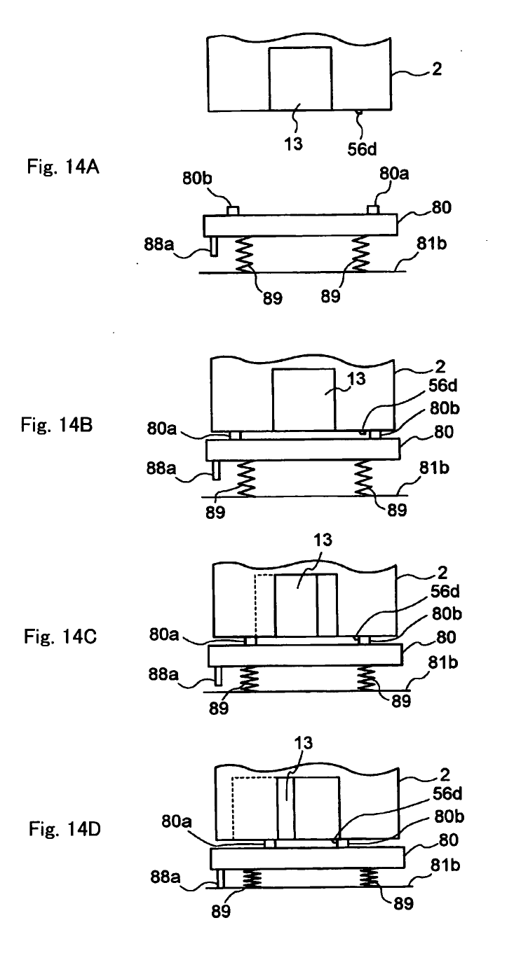

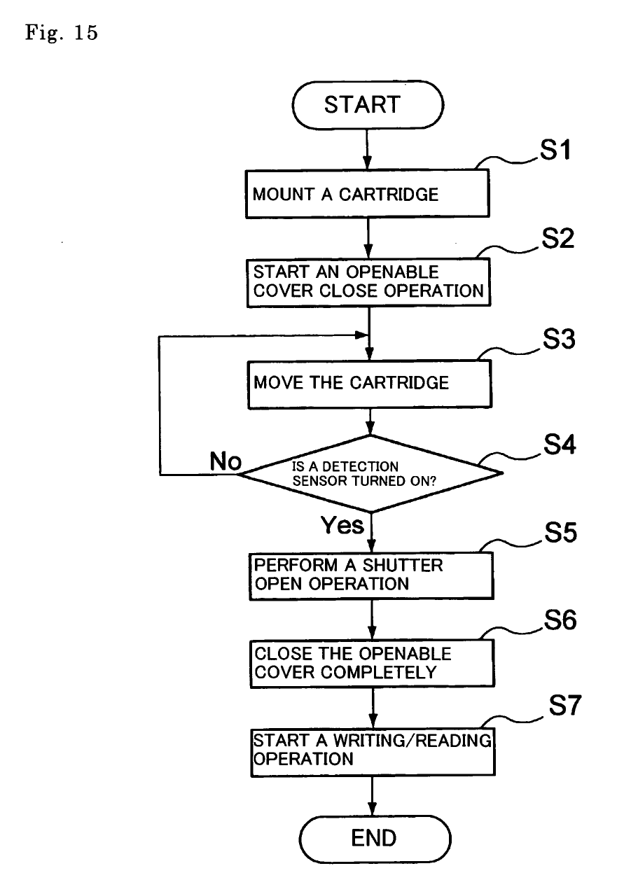

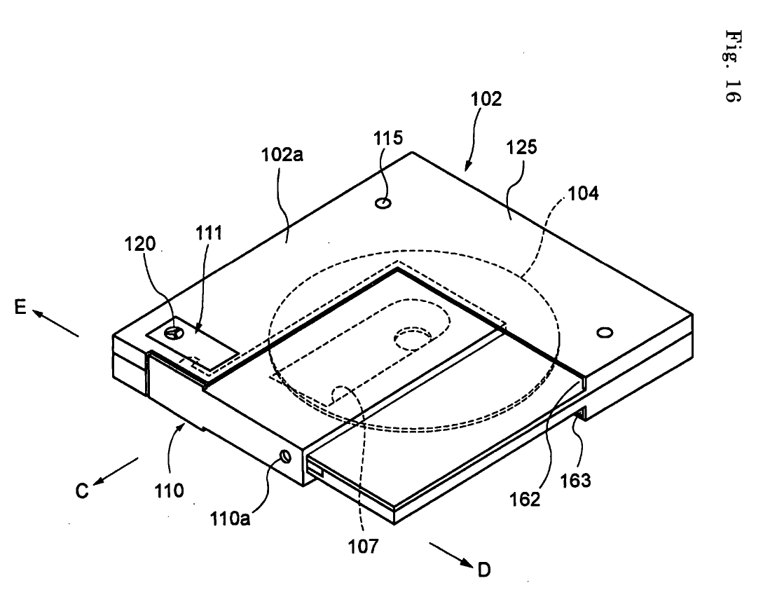

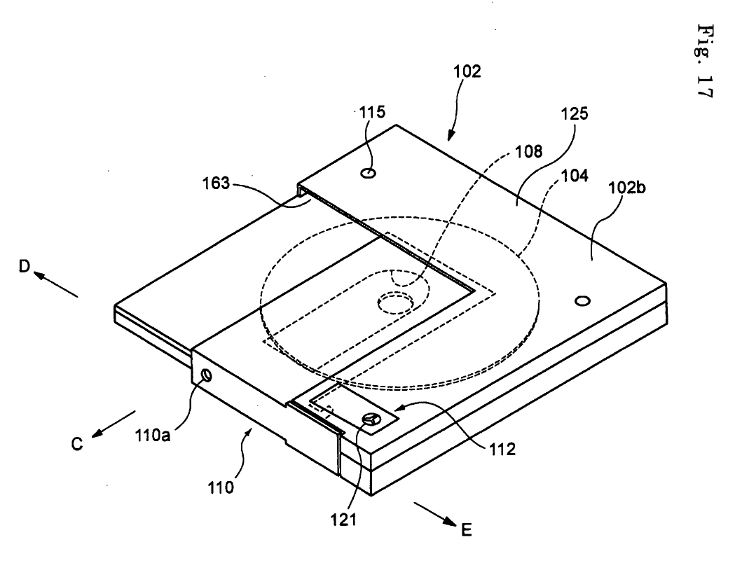

FIGS. 13A to 13E are schematically sectional views for explaining an operation of the recording apparatus. FIGS. 14A to 14D are schematically sectional views for explaining the operation of the recording apparatus. FIG. 15 is a flow chart for explaining control of the recording apparatus.

As shown in FIGS. 13A and 14A, a cartridge 2 is inserted through the mounting port 82 of the recording apparatus 81. As shown in FIGS. 13B and 14B, the cartridge 2 is pushed inward until the front side of the cartridge 2 in the mounting direction abuts on the operating pieces 80a and 80b of the shutter open/close mechanism 80 (step S1).

Next, the openable cover 86 is pushed toward the cartridge body 81a while rotated by the user so that the openable cover 86 in an open state can be closed (step S2).

In this manner, the pressure protrusion 86c of the openable cover 86 abuts on the mounting-direction rear side of the cartridge 2, as shown in FIG. 13C.

When the openable cover 86 is pushed further toward the recording apparatus body 81a side, the cartridge 2 is pushed and moved toward the mounting-direction front side by the pressure protrusion 86c, as shown in FIGS. 13D and 14C (step S3).

In parallel with this, the shutter open/close mechanism 80 is slid toward the mounting-direction front side against the urging force of the compression spring 89 by the mounting-direction front side of the cartridge 2.

When the openable cover 86 is pushed until the shield plate portion 86b of the openable cover 86 goes into the groove portion 87 of the recording apparatus body 81a (see FIGS. 13D and 14C), the mounting port 82 is wholly covered with the openable cover 86 because of fitting of the shield plate portion 86b of the openable cover 86 into the groove portion 87 of the recording apparatus body 81a. Moreover, the shield plate portion 86b of the openable cover 86 is fitted into the groove portion 87 so as to achieve a labyrinth-shaped shielding state in the circumference of the mounting port 82 so that entrance of light or dust in the mounting port 82 is prevented.

At this point of time, the detection pin 88a of the detection sensor 88 of the shutter open/close mechanism 80 slid to the mounting-direction front side abuts on the back plate 81b of the recording apparatus body 81a so as to be pushed back so that a detection signal is outputted from the detection sensor 88 (step S4).

Then, the control portion 91 transmits a drive control signal to the shutter open/close mechanism 80 based on the detection signal transmitted from the detection sensor 88 so as to start an operation for opening the shutter 13 of the cartridge 2 (step S5).

In this manner, due to movement of the operating pieces 80a and 80b of the shutter open/close mechanism 80, the to-be-operated portion 56d as a constituent member of the slide member of the cartridge 2 is engaged with one operating piece 80b and moved. Thus, the shutter 13 is opened.

On this occasion, the mounting port 82 is completely shielded by the openable cover 86 so that entrance of light or dust in the mounting port 82 can be prevented. Accordingly, light or dust does not enter the cartridge 2 even when the shutter 13 of the cartridge 2 is opened by the shutter open/close mechanism 80.

As shown in FIGS. 13E and 14D, when the openable cover 86 is completely pushed to the recording apparatus body 81a (step S6), the cartridge 2 is disposed in a predetermined mounting position in which recording/reproduction can be performed. At this point of time, writing or reading on a recording surface 4b of the recording disc 4 by the recorder/reproducer portion 95 constituted by the spindle motor 83 and the optical pickup 85 is started by the control portion 91 (step S7).

As described above, in the embodiment, the shield plate portion 86b of the openable cover 86 is fitted into the groove portion 87 of the recording apparatus body 81a so as to achieve a labyrinth-shaped shielding state. At the point of time when entrance of light or dust in the mounting port 82 has been prevented, the shutter 13 of the cartridge 2 is opened to thereby start writing/reading to/from the recording surface 4b of the recording disc 4. Thus, a writing/reading operation can be performed rapidly while entrance of light or dust in the cartridge 2 is prevented.

The cartridge applicable to the recording apparatus 81 is not limited to the aforementioned example.

Next, a cartridge having another structure applicable to the recording apparatus 81 will be described in detail with reference to the drawings.

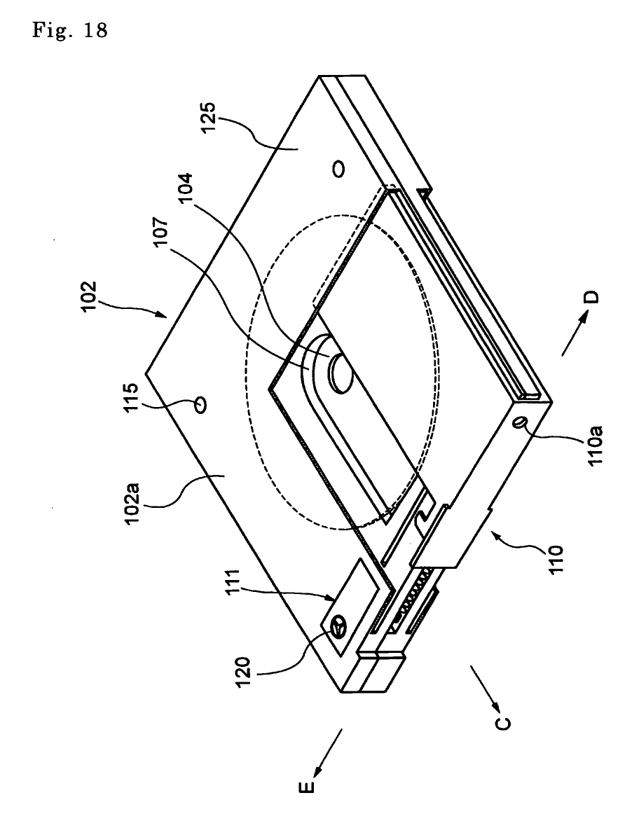

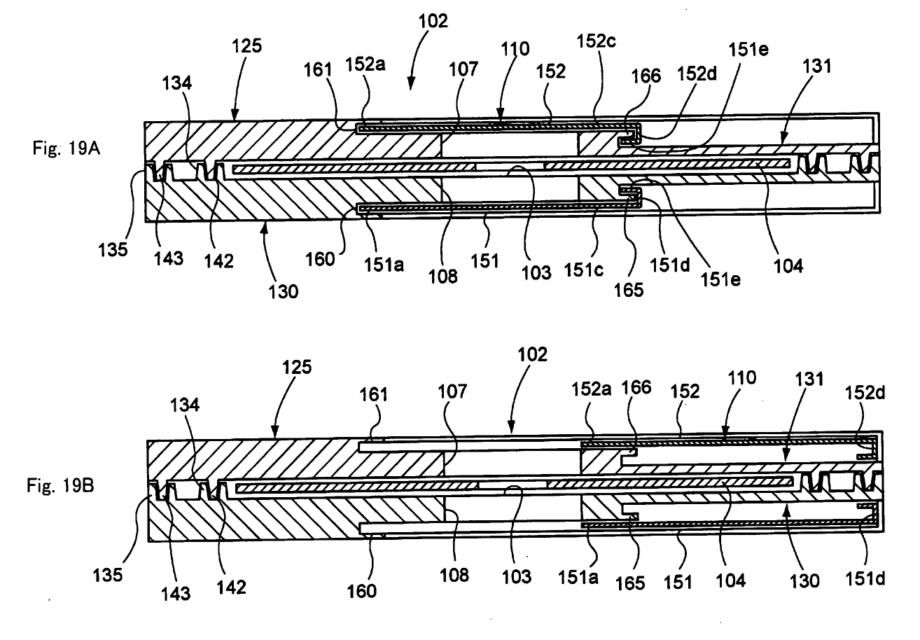

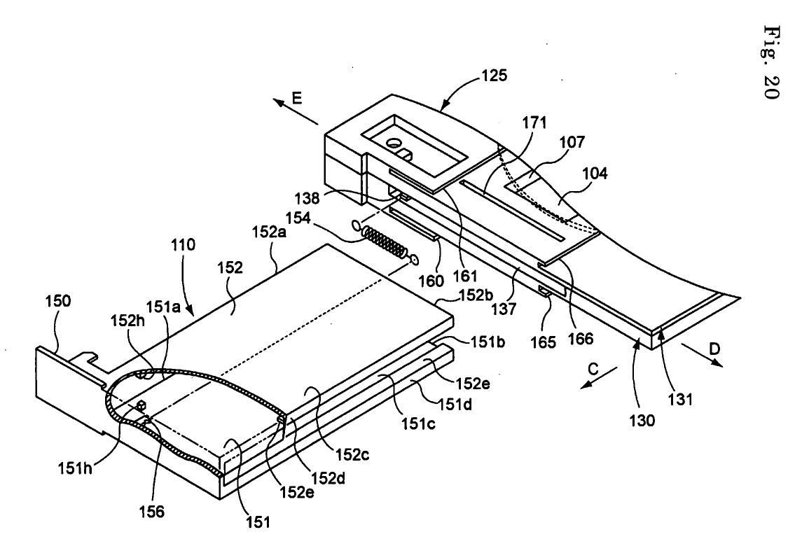

FIGS. 16 to 18 are perspective views each showing the shape of external appearance of the cartridge having the other structure. FIGS. 19A and 19B are important part sectional views of the cartridge in a direction perpendicular to a mounting direction C. FIG. 20 is an exploded perspective view showing the configuration of a shutter.

As shown in FIG. 16, a disc-shaped holographic recording medium (hereinafter referred to recording disc) 104 is stored rotatably in a disc storage portion 103 provided internally in the cartridge 102. The recording disc 104 is dealt with in the condition that the recording disc 104 is stored in the cartridge 102.

The recording disc 104 is a photosensitive recording medium which is shaped like a disc having a hole formed in its central portion and which includes holographic recording layers made of a photosensitive material and provided in opposite surfaces. For example, on each of the holographic recording layers, data are multiplexedly recorded as interference fringes of laser light by the laser light in a range of from a green wavelength of 532 nm to a blue wavelength of 405 nm. Incidentally, a reinforcement material may be added to the hole portion of the recording disc 104.

Also as shown in FIG. 17, openings 107 and 108 for exposing the recording disc 104 stored in the disc storage portion 103 to the outside are formed in an A surface 102a and a B surface 102b of the cartridge 102. In a normal state, these openings 107 and 108 are closed with a shutter 110 provided movably in the outside of the cartridge 102. When the shutter 110 is moved to an open position in a direction of an arrow D, the openings 107 and 108 are opened. The shutter 110 is urged by a spring in a direction of an arrow E which is a close position. The shutter 110 is locked in the close position by lock mechanisms 111 and 112 which are provided in the opposite surfaces of the cartridge 102 so as to operate independently. For this reason, there is no fear that the openings 107 and 108 are opened unintentionally by the shutter 110 moved due to vibration, impact, etc. on the cartridge 102.

The cartridge 102 is inserted into a cartridge slot in the mounting direction C. The cartridge slot is provided in a recording apparatus for recording data onto the recording disc 104 or a reproducing apparatus for reading data from the recording disc 104. The cartridge 102 mounted in the recording apparatus or the reproducing apparatus is positioned by positioning holes 115 provided in opposite ends, and the shutter 110 is moved to the open position so that the openings 107 and 108 are opened. When, for example, the cartridge 102 is mounted in the apparatus in the state shown in FIG. 16, a pickup portion of the apparatus is inserted into the cartridge 102 through the opening 108 of the B surface 102b so that data are recorded or reproduced on/from a lower holographic recording layer of the recording disc 104. When the cartridge 102 is mounted in the apparatus inversely as shown in FIG. 17, the pickup portion is inserted through the opening 107 disposed in the A surface 102a so that data are recorded/reproduced on/from the holographic recording layer of the A surface 102a of the recording disc 104 in FIG. 16.

An unlock mechanism for releasing the lock mechanisms 111 and 112 of the cartridge 102 and a shutter open/close mechanism for moving the shutter 110 between the open position and the close position are incorporated in the recording apparatus and the reproducing apparatus.

In the condition that the lock mechanisms 111 and 112 are released, the shutter open/close mechanism inserts a drive pin into a hole 110a formed in a side surface of the shutter 110 and moves the drive pin in an open direction D. On this occasion, the shutter 110 is movably slid so that the openings 107 and 108 of the opposite surfaces of the cartridge 102 are opened as shown in FIG. 19B.

As shown in FIG. 19A, the cartridge 102 has a cartridge body 125 for storing a recording disc 104 rotatably and a shutter 110 for opening/closing the openings 107 and 108 of the opposite surfaces of the cartridge body 125 from the outside.

The cartridge body 125 includes a first shell 130 substantially shaped like a plate, and a second shell 131 connected to the first shell 130. The first and second shells 130 and 131 are made of one and the same thermoplastic or similar thermoplastics in which a light-shield substance and a lubricant are added.

Various substances can be added as the light-shield substance. For example, it is preferable that 0.01% by weight to 5.00% by weight of a substance are added in accordance with the light-shield substance used. For example, carbon black can be used as the light-shield substance. The amount of carbon black to be added is preferably in a range of from 0.01% by weight to 2.00% by weight. Although an effect in improvement of light-shielding characteristic and physical strength is brought when the amount of carbon black to be added is larger than 0.01% by weight, physical strength is lowered if the amount of carbon black to be added is larger than 2.00% by weight.

For example, a silicone-based lubricant can be used as the lubricant. Because friction resistance is reduced by addition of the silicone-based lubricant, generation of chips due to movement of the shutter 110 can be suppressed. Moreover, generation of chips due to contact between the recording disc 104 and the inner wall of the cartridge body 102 on impact during the transit can be reduced. Moreover, handling property with respect to insertion into the apparatus is improved. In addition, because fluidity is improved, kneading characteristic at molding and processability at injection molding or the like are improved.

Incidentally, the amount of the silicone-based lubricant to be added is preferably in a range of from 0.1% by weight to 3.0% by weight. If the amount is not larger than 0.1% by weight, the effect is reduced. If the amount is not smaller than 3.0% by weight, fluidity is so excessive that a slip is generated between a screw and a resin at the time of kneading and molding. As a result, processability deteriorates, and the lubricant is bled out to a surface of a product and deposited on the recording disc 104, the user's hand or the like. This may cause disadvantages in handling property and external appearance. Incidentally, when copolymer silicone is used as the lubricant, the amount of the lubricant to be added can be increased to 5.0% by weight because such disadvantages hardly occur.

An approximately circular disc storage portion 103 where a recording disc 104 is stored, a first recess 134 provided as a protrusive line so as to enclose the disc storage portion 103, and a second recess 135 provided in the whole circumference of the end edge are provided in the inner surface of the first shell 130.

An inner surface portion 141 forming the disc storage portion 103 of the first shell 130, a first protrusion 142 inserted into the first recess 134 of the first shell 130, a second protrusion 143 inserted into the second recess 135, and a light-shield wall (not shown) provided so as to enclose each positioning hole 115 and inserted into a light-shield wall (not shown) are provided in the inner surface of the second shell 131.

When the second shell 131 is piled on the upper surface of the first shell 130 while the recording disc 104 is placed in the disc storage portion 103, the first protrusion 142 is fitted into the first recess 134. When a front end 142a of the first protrusion 142 fitted into the first recess 134 faces an inner surface 130a of the first shell 130 and a front end 143a of the second protrusion 143 abuts against the inner surface of the first shell 131, a fitting structure is formed.

Since the outer circumference of the disc storage portion 103 is surrounded by the labyrinth-shaped light-shielding structure, light or dust is prevented from entering the disc storage portion 103 through a mating portion between the first shell 130 and the second shell 131.

The second protrusion 143 of the second shell 131 is fixed to the inner surface of the first shell 130 by ultrasonic welding. Thus, the first shell 130 and the second shell 131 are connected to each other firmly, so that no gap is formed in the mating portion between the first shell 130 and the second shell 131. When ultrasonic welding is performed, plastic powder may scatter in the surroundings. When ultrasonic welding is performed in the inside of the second recess 135, the scattering can be however limited to the minimum so that the recording disc 104 can be prevented from being stained.

When the first shell 130 and the second shell 131 are connected to each other by ultrasonic welding after the shutter 110, the lock mechanism 111, etc. have been assembled in the cartridge body 125, other components such as the shutter 110 may be welded together. In order to prevent this, a plastic different in kind from that of each of the first and second shells 130 and 131 may be used as the material of each of the other components such as the shutter 110.

In order to connect the first and second shells 130 and 131 more surely by ultrasonic welding, a protrusion-type energy director may be provided in the front end of the second protrusion 143. When the energy director is used for ultrasonic welding, the ultrasonic energy is concentrated in the energy director so that the second protrusion 143 and the first shell 130 can be welded to each other more firmly. Incidentally, ultrasonic welding between the first shell 130 and the second shell 131 may be performed in the whole circumference of the second protrusion 143 or may be performed in spots at intervals of a fixed pitch.

The shutter 110 is formed from a plastic different in kind from that of each of the first and second shells 130 and 131. A light-shield substance and a lubricant may be added to this plastic, similarly to the plastic used for molding of each of the first and second shells 130 and 131. As shown in FIG. 20, the shutter 110 includes a base portion 150, a first shutter plate 151 and a second shutter plate 152. The base portion 150 is disposed in a side surface of the cartridge body 125 in the mounting direction C. The first and second shutter plates 151 and 152 are formed integrally with the base portion 150 so that the upper and lower surfaces of the cartridge body 25 are held by the first and second shutter plates 151 and 152. A spring peg 156 on which one end of a shutter spring 154 is hung is provided integrally with the inner surface of the base portion 150. The other end of the shutter spring 154 is hung on a spring peg 138 of the first shell 130 so as to be stored in a notch portion 137 so that the shutter 110 is urged to the close position by the shutter spring 154.

Slits 160 and 161 and slits 162 and 163 (see FIGS. 16 and 17) are formed in the outer surfaces of the first and second shells 130 and 131, respectively. The slits 160 and 161 store side end edges 151a and 152a of the shutter plates 151 and 152 in the closing direction E. The slits 162 and 163 stores rear end edges 151b and 152b of the shutter plates 151 and 152 in the mounting direction C. The shutter plate 151 (152) includes a first light-shield plate portion 151c (152c), a second light-shield plate portion 151d (152d), and a third light-shield plate portion 151e (152e). The first light-shield plate portion 151c (152c) is moved slidably so as to open the opening 108 (107). The second light-shield plate portion 151d (152d) is provided erectly and vertically in a front end of the first light-shield plate 151c (152c) on the side where the shutter 110 will be moved to the open position. The third light-shield plate portion 151e (152e) is provided erectly and vertically to the second light-shield plate portion 151d (152d) in the direction of closing the shutter 110. The side end edge of the shutter plate 151 (152) in the opening direction D serves as a bent portion substantially formed into a U shape in section in the opening/closing direction. Protrusive portions 165 and 166 are provided in the outer surfaces of the first and second shells 131 and 132 so as to face the shutter plates 151 and 152. When the shutter 110 is in the close position, the protrusive portion 165 (166) is inserted between the first light-shield plate portion 151c (152c) and the third light-shield plate portion 151e (152e).

In addition, when the shutter 110 is in the close position, the end edges 151a, 151b, 152a, and 152b of the shutter plates 151 and 152 are inserted into the slits 160, 161, 162 and 163 of the shells 130 and 131. The protrusive portions 165 and 166 provided in the shells 130 and 131 enter between the first light-shield plate portions 151c and 152c and the third light-shield plate portions 151e and 152e of the shutter plates 151 and 152. Thus, a labyrinth-shaped light-shielding structure is also formed between the cartridge body 125 and the shutter 110 so that light or dust can be prevented effectively from entering through a gap between the cartridge body 125 and the shutter 110.

As shown in FIG. 20, guide protrusions 151h and 152h are formed in the inner surfaces of the shutter plates 151 and 152 of the shutter 110 and guide grooves 170 and 171 into which the guide protrusions 151h and 152h will be inserted are formed in the outer surfaces of the shells 130 and 131. When the shutter 110 is moved above the outer surface of the cartridge body 125, the guide protrusions 151h and 152h are moved in the inside of the guide grooves 170 and 171. Thus, the shutter 110 can be moved smoothly without being displaced from the cartridge body 125. Incidentally, since a lubricant is added to a plastic as a raw material of each of the first and second shells 130 and 131 and the shutter 110, chips etc. are not generated due to friction when the shutter 110 is moved.

When the cartridge 102 having the aforementioned structure is mounted in the recording apparatus 81, the shield plate portion 86b of the openable cover 86 is fitted into the groove portion 87 of the recording apparatus body portion 81a so as to achieve a labyrinth-shaped light-shielding structure. At the time when entrance of light or dust in the mounting port 82 has been prevented, the shutter 110 of the cartridge 102 is opened so that writing/reading on the recording disc 104 is started. Thus, the writing/reading operation can be performed rapidly while light or dust is prevented from entering the cartridge 102.

### EXAMPLES

An example relating to the cartridge of the invention will be described below.

PC, PBT, ABS, POM, PS, PP, HDPE, PA, PET, PPS, SAN (styrene-acrylonitrile copolymer), PMMA, etc. may be used as the thermoplastics used for molding the first shell and the second shell. With respect to other components than the first shell and the second shell, a material different from the material used for the first shell and the second shell may be selected from the thermoplastics in order to prevent mistaken welding due to ultrasonic welding.

It is preferable that a plastic having light-shielding characteristic exhibiting visible light transmittance of not higher than 1.0% at a thickness of 0.2 mm is used for the first shell and the second shell, and that each shell is formed to have a thickness in a range of from 0.2 to 1.6 mm in order to obtain necessary physical strength. To obtain the plastic having such light-shielding characteristic, a light-shield substance may be added. Various materials can be used as the light-shield substance. It is preferable that 0.01% by weight to 5.00% by weight of a light-shield substance are added in accordance with the light-shield substance used. Examples of the light-shield substance are conceived as follows.

(1) Inorganic Compound
A. Oxide . . . silica, diatomaceous earth, alumina, titanium oxide, iron oxide (iron black), zinc oxide, magnesium oxide, antimony oxide, barium ferrite, strontium ferrite, beryllium oxide, pumice, pumice balloon, alumina fiber, etc.
B. Hydroxide . . . aluminum hydroxide, magnesium hydroxide, basic magnesium carbonate, etc.
C. carbonate . . . calcium carbonate, magnesium carbonate, dolomite, dawsonite, etc.
D. sulfate, sulfite . . . calcium sulfate, barium sulfate, ammonium sulfate, calcium sulfite, etc.
E. silicate . . . talc, clay, mica, asbestos, glass fiber, glass balloon, glass beads, calcium silicate, montmorillonite, bentonite, etc.
F. carbon . . . carbon black, graphite, carbon fiber, carbon hollow sphere, etc.
G. others . . . iron powder, copper powder, lead powder, aluminum powder, molybdenum sulfide, polonium fiber, silicon carbide fiber, brass fiber, potassium titanate, lead titanate zirconate, zinc borate, barium metaborate, calcium borate, sodium borate, aluminum paste, talc, etc.

(2) Organic Compound

Wood flour (pine, oak, saw-dust, etc.), chaff fiber (almond, peanut, rice hulls, etc.), cotton, jute, paper spline, non-wood fiber (straw, Kenaf, bamboo, esparto, bagasse, Jew's mallow, firework, etc.), cellophane piece, Nylon fiber, polypropylene fiber, starch (inclusive of denatured starch and surface-treated starch), aromatic polyamide fiber, etc.

Among these light-shield substances, inorganic compounds which little exert a bad influence on photographic characteristic, which are stable to heat at a temperature of 150° C. or higher and which are opacified are preferred. Light-absorbent carbon black, titanium nitride, graphite and iron black which are substances excellent in heat resistance and light resistance and relatively inactive are especially preferred.

When carbon black is used as the light-shield substance, the amount of carbon black to be added is preferably selected to be in a range of from 0.01% by weight to 2.00% by weight. As described above, the purpose is to obtain a plastic good in the balance of light-shielding characteristic and physical strength.

Examples of classification of raw materials of carbon black include gas black, furnace black, channel black, anthracene black, acetylene black, ketjen carbon black, thermal black, lamp black, oil soot, pine oil soot, animal black, vegetable black, etc.

Typical examples of preferred carbon black available on the market include carbon black #20(B), #30(B), #33(B), #40(B), #41(B), #44(B), #45(B), #50, #100, #600, #950, #1000, #2200(B), #2400(B), MA8, MA11, MA100, etc. made by Mitsubishi Chemical Corporation. Various grades of Denka black made by DENKI KAGAKU KOGYO KABUSHIKI KAISHA, Seast made by TOKAI Carbon Co., Ltd., Asahi #78 made by Asahi Carbon Co., Ltd., Showa black made by Showa Cabot K.K, Niteron made by Nippon Steel Chemical Carbon Co., Ltd., Diamond black made by Mitsubishi Chemical Corp., etc. may be also used.

Examples of overseas products include Black Pearls 2, 46, 70, 71, 74, 80, 81, 607, etc., Regal 300, 330, 400, 660, 991, SRF-S, etc., Vulcan 3, 6, etc., Sterling 10, SO, V, S, FT-FF, MT-FF, etc. made by Cabot Corp. In addition, examples can include United R, BB, 15, 102, 3001, 3004, 3006, 3007, 3008, 3009, 3011, 3012, XC-3016, XC-3017, 3020, etc. made by Ashland Specialty Chemical Company. The invention is not limited thereto.

A silicone-based lubricant can be used as the lubricant added to the first shell and the second shell. Especially, various grades of dimethyl polysiloxane may be used. Various grades of dimethyl polysiloxane available on the market and made by TORAY Industries, Inc., Dow Corning, Silicone, GE Toshiba Silicone Co., Ltd., Wacker Asahikasei Silicone Co., Ltd., Shin-Etsu Chemical Co., Ltd., etc. can be used. Incidentally, either master batch or kneaded article can be used. Incidentally, the amount of the silicone-based lubricant to be added is preferably selected to be in a range of from 0.1% by weight to 5.0% by weight. As described above, the purpose is to obtain a plastic good in balance of friction resistance, product optimization and product quality.

If the surface roughness Ra of the rough surface provided in each shell is not larger than 5 μm, the light-diffusing effect is small. If the surface roughness Ra is not smaller than 20 μm, there is a possibility that the surface of contact with the recording disc will be scratched. For this reason, the surface is preferably matted or embossed with a surface roughness Ra of from 5 to 20 μm.

An Al—Mg-based alloy is preferably used as the aluminum alloy for the light-shield plate 12 and the shutter member 55. For example, JIS alloy Nos. 5052, 5056, etc. are preferred. In order to enhance the strength more greatly, JIS alloy Nos. 5083, 5086, etc. are preferred more especially. In order to enhance the strength further greatly, an Al—Mg—Si-based alloy (such as JIS alloy Nos. 6063 and 6061), an Al—Cu-based alloy (such as JIS alloy Nos. 2014 and 2017), an Al—Zn—Mg-based alloy (such as JIS alloy Nos. 7003, 7N01, 7075 and 7050), etc. may be used. In view from reduction in weight and easiness of processability, it is preferable that the thickness of each of the light-shield plate and the shutter member is not larger than 1.00 mm. More preferably, the thickness is in the range of from 0.15 mm to 0.5 mm.

In addition, each of the light-shield plate and the shutter member may be made of a plastic. As the plastic used, for example, POM etc. is preferred. Similarly to the aforementioned first shell, it is preferable that a light-shield substance and a lubricant are added.

In view from spring constant, durability, processability, etc., stainless steel for austenite-based spring is preferably used as the material of each of the shutter spring and the lock spring. For example, SUS 300 series can be used. The line diameter of the shutter spring is preferably in the range of from 0.2 mm to 0.7 mm. The line diameter of the lock spring is preferably in the range of from 0.15 mm to 0.4 mm.

Although description has been made on the case where the first shell and the second shell are fixed to each other by ultrasonic welding, other welding methods and fixation methods may be used. When, for example, the first and second shells are fixed to each other by screws etc., it is preferable that a light-shielding structure is formed in the circumference of each screw hole. In addition, although each of the second shell and the first shell is formed by one component, each of the second shell and the first shell may be formed by assembling a plurality of components. When, for example, each of the second shell and the first shell is formed by two components with the shutter storage portion as a boundary, mold can be simplified.

Although description has been made on the case where a cartridge for storing a double-side recordable recording disc is taken as an example, the cartridge may be formed for storing a single-side recordable recording disc. In this case, an opening is formed only in one surface and this opening is opened/closed by the shutter. Although description has been made on the case where a cartridge for storing a holographic recording medium is taken as an example, the invention can be applied also to a cartridge for storing a recording medium having another photosensitive characteristic.

This application is based on Japanese Patent application JP 2005-269791, filed Sep. 16, 2005, the entire content of which is hereby incorporated by reference, the same as if set forth at length.

What is claimed is:

1. A recording apparatus comprising:
a shutter open/close mechanism for sliding a shutter of a cartridge mounted into the recording apparatus through a mounting port having an openable cover;
a recorder/reproducer portion for performing reading/writing on a disc-shaped photosensitive recording medium stored in the cartridge in the condition that the shutter has been slid so that an opening formed in a body of the cartridge is opened; and
a control portion for controlling drive of the shutter open/close mechanism and the recorder/reproducer portion, wherein:
the openable cover has a front plate portion for covering the mounting port, and a shield plate portion formed integrally with the circumference of the front plate portion so that the shield plate portion can be fitted into a groove portion formed in the circumference of the mounting port;
the recording apparatus further comprises a detection sensor for detecting the fitting of the shield plate portion of the openable cover into the groove portion in the middle of closing the mounting port with the openable cover; and
when the mounting port is closed with the openable cover after the cartridge is mounted through the mounting port, the control portion drives the shutter open/close mechanism, in response to a detection signal transmitted from the detection sensor, to start a shutter open operation of the cartridge before the openable cover is closed.

2. A photosensitive recording medium cartridge used in a recording apparatus according to claim 1, comprising a light-shield plate attached to the outside of the cartridge body and having an opening hole which faces the opening formed in the cartridge body and which exposes a center and a recording surface of the photosensitive recording medium to the outside.

3. The photosensitive recording medium cartridge according to claim 2, wherein the photosensitive recording medium is a holographic recording medium.

4. The photosensitive recording medium cartridge according to claim 2, wherein the cartridge body is formed so that an inner surface of the cartridge body to the photosensitive recording medium and an outer surface of the cartridge body to the shutter are matted or embossed with a surface roughness Ra of 5 to 20 μm.

5. The photosensitive recording medium cartridge according to claim 3, wherein the cartridge body is formed so that an inner surface of the cartridge body to the photosensitive recording medium and an outer surface of the cartridge body to the shutter are matted or embossed with a surface roughness Ra of 5 to 20 μm.

6. The photosensitive recording medium cartridge according to claim 2, wherein the cartridge body includes a first shell substantially shaped like a plate, and a second shell lap-welded with the first shell, the first and second shells being made of one and the same thermoplastic or similar thermoplastics, the other components inclusive of the shutter being made of materials different from the materials of the first and second shells.

7. The photosensitive recording medium cartridge according to claim 3, wherein the cartridge body includes a first shell substantially shaped like a plate, and a second shell lap-welded with the first shell, the first and second shells being made of one and the same thermoplastic or similar thermoplastics, the other components inclusive of the shutter being made of materials different from the materials of the first and second shells.

8. The photosensitive recording medium cartridge according to claim 2, wherein 0.01% by weight to 5.00% by weight of a light-shield substance are added to a plastic used for molding each of the first and second shells and the shutter.

9. The photosensitive recording medium cartridge according to claim 3, wherein 0.01% by weight to 5.00% by weight of a light-shield substance are added to a plastic used for molding each of the first and second shells and the shutter.

10. The photosensitive recording medium cartridge according to claim 2, wherein 0.01% by weight to 2.00% by weight of carbon black are added to a plastic used for molding each of the first and second shells and the shutter.

11. The photosensitive recording medium cartridge according to claim 3, wherein 0.01% by weight to 2.00% by weight of carbon black are added to a plastic used for molding each of the first and second shells and the shutter.

12. The photosensitive recording medium cartridge according to claim 2, wherein 0.1% by weight to 5.0% by weight of a silicon-based lubricant are added to a plastic used for molding each of the first and second shells and the shutter.

13. The photosensitive recording medium cartridge according to claim 3, wherein 0.1% by weight to 5.0% by weight of a silicon-based lubricant are added to a plastic used for molding each of the first and second shells and the shutter.
